(19) United States
(12) Patent Application Publication
(10) Pub. No.: US 2013/0215180 A1
(43) Pub. Date: Aug. 22, 2013

(54) Printing Apparatus and Printing Method

(71) Applicant: SEIKO EPSON CORPORATION, (US)

(72) Inventor: Kazumi YAMADA, Azumino-shi (JP)

(73) Assignee: SEIKO EPSON CORPORATION, Tokyo (JP)

(21) Appl. No.: 13/759,853

(22) Filed: Feb. 5, 2013

(30) Foreign Application Priority Data
Feb. 16, 2012 (JP) 2012-031437

(51) Int. Cl. B41F 23/08

(52) U.S. Cl. CPC B41F 23/08
USPC 347/15

(57) ABSTRACT

A printing apparatus that prints onto a printed object using a special glossy ink and a color ink includes a control unit that executes the print adding the special glossy ink to locations in which the pixels formed by the color ink have a maximum luminance or saturation.

### CROSS-REFERENCE TO RELATED APPLICATIONS

The entire disclosure of Japanese Patent Application No. 2012-31437, filed Feb. 16, 2012 is expressly incorporated by reference herein.

### BACKGROUND

1. Technical Field

The present invention relates to printing apparatuses and printing methods.

2. Related Art

In recent years, printing techniques that use a special glossy ink, such as metallic ink, are being proposed. For example, the technique disclosed in JP-A-2010-76317 (see abstract) carries out printing that achieves both a sense of texture from a special glossy ink and color expressivity from color ink by specifying the color ink that is used the most when printing an image to be printed as a single primary ink; printing is executed after performing a halftone process through an ordered dithering method that continuously uses the same dither mask, so that when a metallic ink dot is “on”, the primary ink dot is not “on”, or in other words, so that the metallic ink dots and the primary ink dots do not overlap with each other.

When printing is carried out using a special glossy ink such as metallic ink, it is common to use a metallic plate for determining where and how much of the special glossy ink is to be added to the image to be printed, and the printing technique disclosed in JP-A-2010-76317 also executes printing based on a metallic ink plate configured by a user through an operating panel or the like. Accordingly, past printing methods that use a special glossy ink have required the user to prepare a metallic plate him or herself before executing the print, and have thus been troublesome for the user.

### SUMMARY

It is an advantage of some aspects of the invention to provide an image forming apparatus and an image forming method capable of forming image data with ease using a special glossy ink, without requiring a user to explicitly specify how the special glossy ink is to be applied to an image to be printed.

An image forming apparatus according to one aspect of the invention includes an image input unit that inputs image data configured of a plurality of pixels; an image processing unit that determines pixels to which a special glossy ink is to be added based on a predetermined determination standard for at least one image feature amount including the saturation, brightness, and hue of each pixel in first color space information of the image data inputted from the image input unit; a color conversion unit that converts the image data in the first color space information into image data expressed as second color space information, based on the image data inputted from the image input unit and information of pixels to which the special glossy ink is to be added determined by the image processing unit; and an image forming unit that generates print data based on the image data obtained through the color conversion performed by the color conversion unit. Through this, the locations to which the special glossy ink is to be added are determined automatically in accordance with the image feature amount of the image data that is to be printed; accordingly, image data that uses the special glossy ink can be formed with ease, without a user explicitly specifying where the special glossy ink is to be added.

In addition, the image processing unit can determine the pixels to which the special glossy ink is to be added based on a predetermined determination standard that combines a plurality of any of the image feature amounts of the saturation, brightness, and hue of a pixel in the image data in the first color space information. Through this, a condition for determining where to add the special glossy ink is made by combining a plurality of image feature amounts; accordingly, it is possible to form image data that more easily obtains a metallic sense through the special glossy ink, as compared to performing the determination using a single image feature amount.

An image forming method according to another aspect of the invention includes an image input step of inputting image data configured of a plurality of pixels; an image processing step of determining pixels to which a special glossy ink is to be added based on a predetermined determination standard for at least one image feature amount including the saturation, brightness, and hue of each pixel in first color space information of the image data inputted in the image input step; a color conversion step of converting the image data in the first color space information into image data expressed as second color space information, based on the image data inputted in the image input step and the information of pixels to which the special glossy ink is to be added determined in the image processing step; and an image forming step of forming print data based on the image data obtained through the color conversion performed in the color conversion step. Through this, the locations to which the special glossy ink is to be added are determined automatically and appropriately in accordance with the image feature amount of the image data; accordingly, image data that uses the special glossy ink can be formed with ease, without a user explicitly specifying where the special glossy ink is to be added.

According to the invention, it is possible to provide an image forming apparatus and an image forming method capable of forming image data with ease using a special glossy ink, without requiring a user to explicitly specify how the special glossy ink is to be applied to an image to be printed.

### BRIEF DESCRIPTION OF THE DRAWINGS

The invention will be described with reference to the accompanying drawings, wherein like numbers reference like elements.

FIG. 1 is a block diagram illustrating the primary elements of a printer according to an embodiment of the invention.

FIG. 2 is a flowchart illustrating a printing process performed by the printer illustrated in FIG. 1.

FIG. 3 is a flowchart illustrating a process for generating metallic ink addition information.

FIG. 4 is a diagram illustrating an example of an image to which metallic ink has been added.

FIG. 5 is a diagram illustrating an example of an image to which metallic ink has been added.

### DESCRIPTION OF EXEMPLARY EMBODIMENTS

Hereinafter, an embodiment of the invention will be described in detail with reference to the drawings. Note that a printer 10 described as an example of an image forming apparatus hereinafter is assumed to include a printing head (not shown) in which are installed color ink ink cartridges that hold cyan ink (C), magenta ink (M), yellow ink (Y), and black ink (Bk) as color inks and a metallic ink ink cartridge that holds metallic ink (S) serving as an example of a special glossy ink; the printer 10 is also assumed to carry out printing using both the color inks and the metallic ink. Note that “color ink” as referred to in this embodiment also includes black ink. However, black ink may also be excluded from the concept of “color ink”.

“Metallic ink”, meanwhile, is ink that expresses a metallic sense in the printed object, and, for example, an oil-based ink composition containing a metallic pigment, an organic solvent, and a resin can be used as such a metallic ink. In order to effectively produce a visual sense of being metallic, it is preferable for the stated metallic pigment to be realized as flat particles, and when the major axis of the flat particles is taken as X, the minor axis as Y, and the thickness as Z, it is preferable for a mean particle diameter R50 that is 50% of the equivalent diameter of a circle found based on the surface area of the X-Y plane of the flat particle to be 0.5 to 3 μm, and for R50/Z>5 to hold true. This metallic pigment can be formed from, for example, aluminum, an aluminum alloy, or the like, and can also be created by fracturing a metal deposited film. The concentration of the metallic pigment contained in the metallic ink can be set to, for example, 0.1 to 10.0 wt %. Of course, the metallic ink is not limited to this composition, and any other composition can be employed as appropriate as long as it is a composition that is capable of producing a metallic sense. For example, a dye ink in which ink ejected onto a print medium permeates into an ink absorption layer and expresses color through the ink absorption layer may be used.

In this embodiment, the composition of the metallic ink is as follows: aluminum pigment, 1.5 wt %; glycerin, 20 wt %; triethylene glycol monobutyl ether, 40 wt %; BYK-UV3500 (manufactured by BYK Japan KK), 0.1 wt %.

In addition, “pixel” as referred to hereinafter typically indicates a “pixel” in image data, but may also indicate a “pixel” in a printed image that is the result of printing. Furthermore, “image” as referred to hereinafter typically indicates all or part of a printed image that is the result of printing, but may also indicate part or all of a piece of “image data”.

Further still, although the following describes the image forming apparatus as being configured only of the printer 10, a program (a printer driver) for causing the printer 10 to execute a printing process may be installed in a personal computer (not shown), and these devices may collectively configure a single image forming apparatus. The program mentioned here may also include an application program in addition to the printer driver.

### Overview of Printer 10

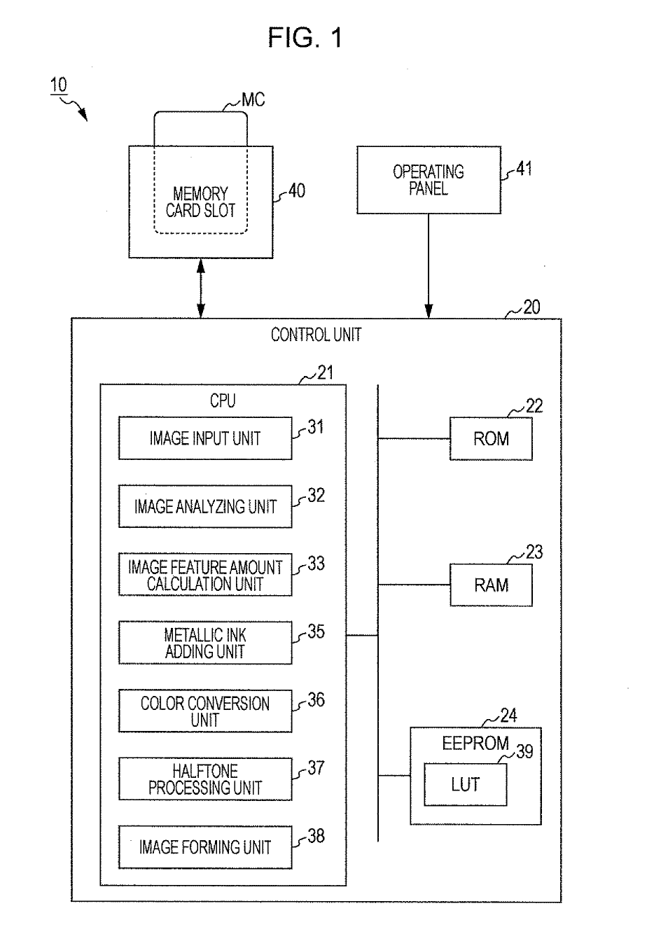

FIG. 1 is a block diagram illustrating primary elements of the printer 10 that embodies an image forming apparatus according to the invention. This printer 10 includes a control unit 20. The control unit 20 is configured so as to include a CPU 21, a ROM 22, a RAM 23, and an EEPROM 24 that are connected to each other via a bus. Furthermore, by expanding programs stored in the ROM 22, the EEPROM 24, and so on in the RAM 23 and executing the programs, the control unit 20 also functions as an image input unit 31, an image analyzing unit 32, an image feature amount calculation unit 33, a metallic ink adding unit 35, a color conversion unit 36, a halftone processing unit 37, and an image forming unit 38. Details of these functional units will be given later. An LUT (look-up table) 39 for converting RGB tone values and metallic ink addition information SA (an example of pixel information; this will be described later) into respective CMYK and metallic ink S tone values, is stored in the EEPROM 24.

A memory card slot 40 is connected to the control unit 20, and image data ORG can be loaded and inputted from a memory card MC that has been inserted into the memory card slot 40. In this embodiment, the image data ORG inputted from the memory card MC is data configured of three color components, or red (R), green (G), and blue (B). Note that the image data ORG inputted to the control unit 20 need not be loaded from the memory card MC, and may be loaded from a digital still camera, a personal computer, a USB memory, or the like instead.

In addition, the control unit 20 can receive an instruction from a user through an operating panel 41 or the like and determine whether or not to add a metallic color to the inputted image data ORG. Upon receiving an instruction to add a metallic color from the user, the control unit 20 can determine, based on a predetermined determination standard, pixels or a region configured of the metallic color (called a “metallic region” hereinafter) that is separate from pixels or regions configured of one of the respective R, G, and B color components (called “color regions” hereinafter). Note that the metallic regions and color regions may overlap or may not overlap (an overlapping region will be referred to as a “metallic color region”). In addition, dots formed by color ink and dots formed by the metallic ink S within the same region may be printed in a ed manner, or the color ink and the metallic ink S may be printed individually, independent from each other.

The printer 10 configured as described above can, for the image data ORG inputted from the memory card MC, automatically determine locations on a print medium where a metallic color is to be added in the case where the user wishes to print using a metallic color, and can form image data using the metallic color and print that image data with ease.

### Printing Process

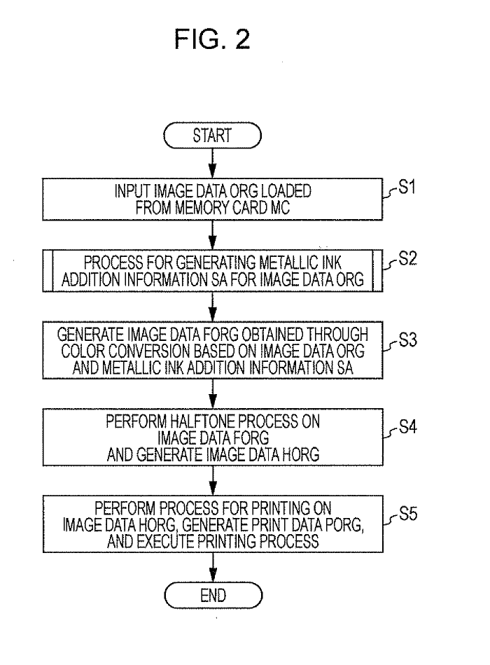

Next, a printing process performed by the printer 10 will be described. FIG. 2 is a flowchart illustrating a printing process executed by the control unit 20 of the printer 10 illustrated in FIG. 1. Note that this printing process is started, for example, in response to an instruction being received from the user via the operating panel 41 or the like.

In step S1, the image input unit 31 of the control unit 20 inputs the image data ORG loaded from the memory card MC. Specifically, the image input unit 31 inputs the loaded image data ORG into the image analyzing unit 32.

In step S2, the image analyzing unit 32, the image feature amount calculation unit 33, and the metallic ink adding unit 35 of the control unit 20 generate the metallic ink addition information SA for the image data ORG. Note that the specific process for generating the metallic ink addition information SA for the image data ORG will be described later. The image data ORG and the metallic ink addition information SA are supplied to the color conversion unit 36.

In step S3, the color conversion unit 36 of the control unit 20 generates image data FORG from the image data ORG and the metallic ink addition information SA by referring to the LUT 39. Specifically, the color conversion unit 36 refers to the LOT 39 and generates the so-called metallic plate by converting the metallic ink addition information SA generated in the process of step S2 into pixels to which the metallic ink S is to be added and tone values corresponding to the ink color of the metallic ink S, and refers to the LUT 39 and converts the image data ORG from the RGB color system into color inks that can be expressed by the printer 10. In other words, in step S3, the image data FORG is generated using color space information (color ink and metallic ink) that can be expressed by the printer 10. The image data FORG is then supplied to the halftone processing unit 37.

In step S4, the halftone processing unit 37 of the control unit 20 performs a halftone process on the image data FORG, and generates image data HORG. Specifically, the halftone processing unit 37 generates the image data HORG by performing a process that uses a dot distribution to set the dots in each ink color to “on” or “off” according to the respective tone values indicated by the image data FORG that has been color-converted by the color conversion unit 36. Note that the process executed by the halftone processing unit 37 can employ a known dithering method, an error diffusion method, a density pattern method, or the like. The image data HORG is then supplied to the image forming unit 38.

In step S5, the image forming unit 38 of the control unit 20 carries out a process for printing on the image data HORG, forms print data PORG, and executes a printing process. Specifically, the image forming unit 38 forms the print data PORG by rearranging the arrangement of the image data HORG into an order that is to be transferred to a printing head (not shown) of the printer 10, and executes the printing process.

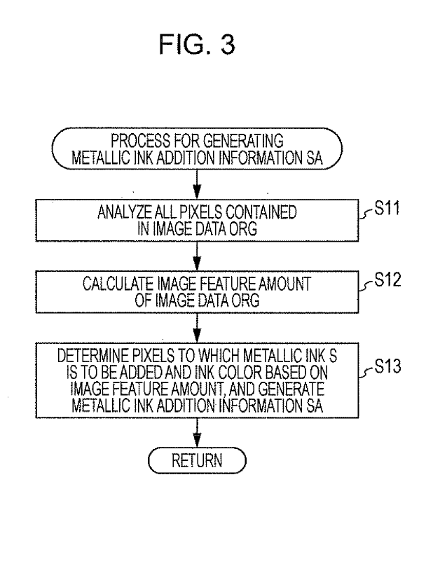

FIG. 3 is a flowchart illustrating details of the process for generating the metallic ink addition information SA in step S2 of FIG. 2. In step S11, the image analyzing unit 32 analyzes all of the pixels in the image data ORG. For example, the image analyzing unit 32 analyzes the tone values of the three color components, or red (R), green (G), and blue (B), for all of the pixels contained in the image data ORG, on a pixel-by-pixel basis.

In step S12, the image feature amount calculation unit 33 calculates an image feature amount of the image data ORG based on the elements analyzed by the image analyzing unit 32. For example, the image feature amount calculation unit 33 calculates an image feature amount based on one or more of information indicating a maximum value and a minimum value of a brightness (luminance), a range and average value of a hue, a maximum value, minimum value, and average value of a saturation, and so on in the overall image data ORG, from the tone values of the three color components, or red (R), green (G), and blue (B), that are contained in the image data ORG analyzed by the image analyzing unit 32 and that have been analyzed on a pixel-by-pixel basis. Note that the image feature amount calculated here by the image feature amount calculation unit 33 is dependent on the predetermined determination standard used by the metallic ink adding unit 35 to determine which pixels to add the metallic ink S2 (this will be described later). For example, in the case where the predetermined determination standard is a determination standard that finds the pixels in the image data ORG that have the maximum luminance and applies the metallic ink S to that range, the image feature amount calculation unit 33 can calculate position information indicating the pixel whose luminance is the maximum value and a region in the periphery of that pixel. In other words, the image feature amount calculation unit 33 can specify the pixel having the highest tone value for the green (G) color component and a region in the periphery of that pixel as the pixels having the maximum luminance value, and can calculate position information indicating that region as the image feature amount.

In step S13, upon receiving the image feature amount calculated by the image feature amount calculation unit 33, the metallic ink adding unit 35 determines the pixels to which the metallic ink S is to be added and the ink color of the metallic ink S. For example, the metallic ink adding unit 35 sets a flag for adding the metallic ink S in the pixels included in a predetermined range from the position of the pixel, received from the image feature amount calculation unit 33, that has the highest tone value for the green (G) color component, and sets the ink color of the metallic ink S so that the tone value of the metallic ink S drops the further away the pixel is from the pixel that has the highest tone value for the green (G) color component, or in other words, so that a gradation is produced. Then, the metallic ink adding unit 35 supplies, to the color conversion unit 36, the pixels in which the flag for adding the metallic ink S has been set along with ink amount information of the metallic ink S for each pixel in which the flag for adding the metallic ink S has been set (that is, the metallic ink addition information SA). Because the metallic ink addition information SA is automatically generated from the image feature amount of the image data ORG in this manner, it is not necessary for the user to explicitly specify the locations to which the metallic ink S is to be added.

### Example of Printed Image

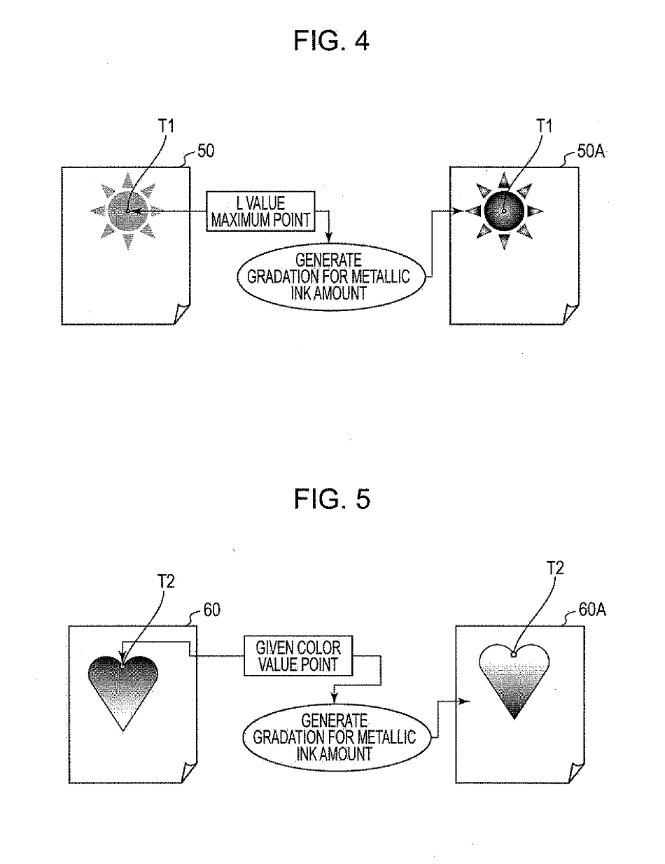

FIG. 4 is a diagram schematically illustrating a relationship between an image 50 outputted based on image data inputted into the printer 10 shown in FIG. 1 and an image 50A outputted based on image data formed as a result of the processing illustrated in FIGS. 2 and 3. The image 50A shown in FIG. 4 has been generated with the metallic ink S being added to the pixels within a predetermined range (in this example, the pixels contained within an object) that is centered on a pixel T1 having the maximum luminance value (a maximum point for an L value) in the image 50, and with gradation produced so that the ink color (tone value) of the metallic ink S decreases the further away the pixel is from the pixel T1; as a result, an image in which the metallic ink S is added to locations where a metallic sense is easily expressed has been formed.

### Effects of the Embodiment of the Invention

As described thus far, the printer 10 according to this embodiment includes the image input unit 31 that inputs the image data ORG configured of a plurality of pixels; the metallic ink adding unit 35 (image processing unit) that determines pixels to which the metallic ink S (a special glossy ink) is to be added based on a predetermined determination standard for at least one image feature amount including the saturation, brightness, and hue of each pixel in an RGB color system serving as first color space information of the image data ORG inputted from the image input unit 31; the color conversion unit 36 that converts the image data ORG in the RGB color system serving as the first color space information into the image data FORG expressed as the CMYK color system and a metallic color that serve as second color space information, based on the image data ORG inputted from the image input unit 31 and the metallic ink addition information SA (the information of pixels to which the metallic ink S is to be added) determined by the metallic ink adding unit 35; and the image forming unit 38 that generates the print data PORG based on the image data HORG obtained by performing a halftone process on the image data FORG obtained through the color conversion performed by the color conversion unit 36. Accordingly, the print data PORG (image data) can be formed with ease using the metallic ink S, without the user explicitly preparing a metallic plate for specifying where the metallic ink S is to be added. In addition, because the metallic ink S is automatically used in locations where it is preferable to express a metallic sense, it is possible to obtain a visual effect (an appearance of metal) while suppressing costs more than in the case where the metallic ink S is used without regard for the image feature amount.

Although the predetermined determination standard used when performing the process for generating the metallic ink addition information SA shown in FIG. 3 is described as forming a gradation by causing the amount of the metallic ink S to decrease outward from the pixel corresponding to the maximum brightness (luminance) point in the image data ORG, it should be noted that the determination standard may be as described hereinafter. For example, the determination standard for adding the metallic ink S may be: (1) adding the metallic ink S to pixels included in a specific range from the brightness (luminance) in the image data ORG (for example, a specific range in which there is a series of continuous pixels whose green (G) color component tone values are greater than or equal to 100); (2) adding the metallic ink S to pixels included in a region corresponding to a range spanning from a maximum saturation point in the image data ORG to a specific saturation; (3) adding the metallic ink S only to a region in which the hue or the saturation in the image data ORG is in a specific range; (4) adding the metallic ink S so that the color of the metallic ink S changes in accordance with a change in a color in a region corresponding to a range from a specific hue or a range from a specific saturation; or (5) adding the metallic ink S to pixels included in a region that corresponds to a combination of any of the aforementioned (1) through (4). Image data can be obtained with ease using the metallic ink S when using such settings as well. In addition, because the metallic ink S is automatically used in locations where it is preferable to express a metallic sense, it is possible to obtain a visual effect (an appearance of metal) while suppressing costs more than in the case where the metallic ink S is used without regard for the image feature amount. It is particularly easy to obtain a better visual effect with the metallic ink (an appearance of metal) if the determination is carried out using a combination of a plurality of image feature amounts as the predetermined conditions for determining where to add the metallic ink S. Note that because the specific numerical values for the specific regions discussed in the aforementioned (1) through (5) will differ depending on the target image, those numerical values may be determined within a range designed as appropriate by one skilled in the art.

FIG. 5 is a diagram schematically illustrating a relationship between an image 60 outputted based on image data inputted into the printer 10 shown in FIG. 1 and an image 60A outputted based on image data formed by adding, in the processing illustrated in FIGS. 2 and 3, the metallic ink S based on pixels having a hue value in a specific range or a saturation value in a specific range. With the image 60A shown in FIG. 5, the pixels to which the metallic ink S is to be added and the color of the metallic ink S are determined in accordance with changes in the hue, saturation, and so on in a range from a pixel T2 that has a hue value in a specific range or a saturation value in a specific range in the image 60. Accordingly, with the image 60A shown in FIG. 5, the color of the heart image lightens from the top (that is, the side on which the pixel T2 is located) toward the bottom, and the pixels to which the metallic ink S is to be added and the color of the metallic ink (the tone values) are determined in accordance therewith, from the top to the bottom of the heart image. As a result, a gradation is produced in the metallic ink S from the top of the heart image to the bottom of the heart image.

An image forming method employed by the printer 10 according to this embodiment includes an image input step of the image input unit 31 inputting the image data ORG configured of a plurality of pixels; a metallic ink adding step (image processing step) of the metallic ink adding unit 35 determining pixels to which the metallic ink S (a special glossy ink) is to be added based on a predetermined determination standard for at least one image feature amount including the saturation, brightness, and hue of each pixel in an RGB color system serving as first color space information of the image data ORG inputted in the image input step; a color conversion step of the color conversion unit 36 converting the image data ORG in the RGB color system serving as the first color space information into the image data FORG expressed as the CMYK color system and a metallic color that serve as second color space information, based on the image data ORG inputted in the image input step and the metallic ink addition information SA (the information of pixels to which the metallic ink S is to be added) determined in the metallic ink adding step; and an image forming step of the image forming unit 38 forming the print data PORG based on the image data HORG obtained by performing a halftone process on the image data FORG obtained through the color conversion performed in the color conversion step. Accordingly, the print data PORG (image data) can be obtained with ease using the metallic ink S, without the user explicitly preparing a metallic plate for specifying where the metallic ink S is to be added. In addition, because the metallic ink S is automatically used in locations where it is preferable to express a metallic sense, it is possible to obtain a visual effect (an appearance of metal) while suppressing costs more than in the case where the metallic ink S is used without regard for the image feature amount.

### Other Variations

This invention is not intended to be limited to the aforementioned embodiments, and in practice, various inventions can be obtained by varying and specifying the constituent elements thereof, combining as appropriate a plurality of constituent elements disclosed in the aforementioned embodiments, and so on without departing from the essential spirit of the invention. For example, although the aforementioned embodiments describe the first color space information of the image data ORG as color space information of the RGB color system and the second color space information as color space information for conversion into the CMYK color system and a metallic color, the color space information in the first color space information and the second color space information aside from the metallic color may employ color space information aside from the RGB color system (for example, the CIE color system, the XYZ color system, the L*u*v* color system, the L*a*b* color system, the Munsell color system, and so on). In addition, although the process for generating the metallic ink addition information SA shown in FIGS. 2 and 3 is described as being carried out prior to the color conversion process for output through the printer 10, this generation process may be carried out after the color conversion process.

Furthermore, some constituent elements described in the aforementioned embodiments may be omitted. Further still, the constituent elements belonging to different embodiments may be combined as appropriate.

What is claimed is:

1. A printing apparatus that prints onto a printed object using a special glossy ink and a color ink, the apparatus comprising:
a control unit that executes a print adding the special glossy ink to locations in which pixels formed by the color ink have a maximum luminance or saturation.

2. The printing apparatus according to claim 1,
wherein the control unit executes the print also adding the special glossy ink to the periphery of the locations in which the pixels formed by the color ink have a maximum luminance or saturation.

3. The printing apparatus according to claim 2,
wherein the control unit executes the print so that a tone value of the special glossy ink is higher in the locations in which the pixels formed by the color ink have a maximum luminance or saturation than in the periphery.

4. The printing apparatus according to claim 3,
wherein the control unit executes the print so that the tone value of the special glossy ink is the highest in the locations in which the pixels formed by the color ink have a maximum luminance or saturation, and the tone value of the special glossy ink decreases as the locations move away from the locations in which the pixels formed by the color ink have a maximum luminance or saturation.

5. The printing apparatus according to claim 1,
wherein the special glossy ink is not added to locations aside from the locations having a maximum luminance or saturation.

6. The printing apparatus according to claim 2,
wherein the special glossy ink is not added to locations aside from the locations having a maximum luminance or saturation and the periphery of the locations having a maximum luminance or saturation.

7. A printing method that prints onto a printed object using a special glossy ink and a color ink, the method comprising:
executing the print adding the special glossy ink to pixels that, of the pixels formed by the color ink, have a maximum luminance or saturation.
